(19) United States
(12) Patent Application Publication
(10) Pub. No.: US 2018/0165678 A1
(43) Pub. Date: Jun. 14, 2018

(54) METHODS AND SYSTEMS FOR PROCESSING A PAYMENT TRANSACTION

(71) Applicant: Mastercard International Incorporated, Purchase, NY (US)

(72) Inventors: Gokul Sathyaseelan Kajal, Kollam (IN); Shivendra Dubey, Pune (IN); Ajay Sinha, Pune (IN)

(73) Assignee: Mastercard International Incorporated, Purchase, NY (US)

(21) Appl. No.: 15/842,100

(22) Filed: Dec. 14, 2017

(30) Foreign Application Priority Data
Dec. 14, 2016 (SG) 10201610474T

(51) Int. Cl. G06Q 20/36; G06Q 20/40; G06Q 20/34; G06F 17/30

(52) U.S. Cl. CPC G06Q 20/3674; G06F 17/30979; G06Q 20/34; G06Q 20/401

(57) ABSTRACT

Methods and systems for processing a payment transaction associated with a purchase made at a merchant are disclosed. The proposed disclosure involves an authorization engine component of an issuer system of a payment card receiving a payment authorization request message associated with the purchase from a payment network server, and generating an authorization response message indicative of an outcome of the payment authorization request for communication to the merchant's terminal. The issuer system has a response-generation engine component configured to identify supplementary data which has been pre-registered by the associated cardholder at the issuer system, and to include the supplementary data in the authorization response message so that the merchant's terminal may extract the supplementary data, and may use the extracted data to initiate another transaction, such as a loyalty transaction or digital-wallet payment transaction, which is related to the purchase.

### CROSS-REFERENCE TO RELATED APPLICATIONS

This application claims the priority benefit of Singapore Application No. 10201610474T, filed Dec. 14, 2016, which is incorporated herein by reference in its entirety.

### TECHNICAL FIELD

The present invention relates to methods and systems for processing payment transactions.

### BACKGROUND

It is common for a merchant to organize a loyalty program for its customers. Typically, a customer is provided with a physical loyalty card, which is typically a piece of paper or plastic carrying an account number. The account number is the number of a loyalty account for storing loyalty rewards, e.g., loyalty points earned by the customer. Whenever the customer makes a purchase at a point-of-sale (POS) of the merchant they present the loyalty card. Depending on the value and/or the type of the purchase, the merchant determines a corresponding number of loyalty points, and credits that number of loyalty points to the account associated with the corresponding card. The accumulated loyalty points can be used to obtain rewards, such as goods and/or services (collectively referred to here as “products”) or a discount on a future purchase from the merchant.

However, sometimes a customer may forget to bring his or her loyalty card to the merchant when a purchase is to be made. In such circumstances, often the customer may not be able to benefit from the loyalty points, leading to customer regret. In certain cases, the customer may decide not to make the purchase, leading to loss of sales to the merchant. Also, customer who is a member of a large number of loyalty programs organized by respective merchants is particularly unlikely to wish to carry all cards for all merchants at all times. This further increases the chance that the appropriate loyalty card will not available when the customer goes to the merchant.

Therefore, it is desirable to provide a method and system for improving customers' purchasing experience when making a transaction with the merchant, for example, for enhancing customer experience on the loyalty program operated by the merchant.

### SUMMARY OF THE DISCLOSURE

In general terms, the present disclosure proposes an issuer system storing supplementary data relating to a payment card of a cardholder (such as the cardholder's loyalty account information with merchants, or digital wallet account information) pre-registered by the cardholder, and incorporating the supplementary data in a payment authorization response message for a payment transaction carried out by the cardholder. This may allow user-specified information to be provided to the merchant's terminal automatically for transactions carried out by the cardholder.

According to a first aspect, there is provided a method for processing a payment transaction associated with a purchase made at a merchant. The payment transaction involves a payment card associated with an issuer system. The method comprises:

(a) receiving a payment authorization request message from a payment network, said payment authorization request message specifying said payment transaction to the merchant, and
(b) in response to the payment authorization request message, generating a payment authorization response message indicative of an outcome of the payment authorization request for communication to a terminal of the merchant;
wherein operation (b) further comprises:
(i) identifying supplementary data associated with a cardholder of the payment card, wherein the supplementary data comprises data pre-registered by the cardholder with the issuer system, and
(ii) incorporating the supplementary data in the payment authorization response message for communication to the terminal of the merchant for extraction by the merchant.

Typically, this method may be performed by the issuer system. The proposed method may allow data pre-registered by respective individual cardholders to be provided to the merchant's terminal automatically, so that relevant data corresponding to the cardholder may be extracted to allow a related transaction to be initiated at the merchant. For example, the merchant may extract from the payment authorization response message the loyalty account (e.g. a membership ID) held by the cardholder who is making a purchase at the merchant, and may correspondingly credit loyalty points earned for the purchase automatically into his or her loyalty account.

In addition, this may speed up the process of the purchase, as the customer does not have to present both the payment card and the loyalty card, as locating an appropriate loyalty card in his or her wallet may be time consuming especially when the customer is a member of many loyalty programs.

In some embodiments, operation (i) may comprise interrogating a database storing a respective set of data pre-registered by the cardholder for each of a plurality of merchants, and identifying the set of data corresponding to the merchant as the supplementary data.

In some embodiments, the database may be updated by receiving user-specified data from a communication device associated with the cardholder, and storing an association between the user-specified data and the cardholder in the database. The association may specify an association between the user-specified data and the payment card. The database may store data pre-registered by each of a plurality of cardholders.

In some embodiments, the supplementary data may comprise data identifying a loyalty account associated with the cardholder. In one example, the loyalty account is associated with the merchant.

In some embodiments, the payment authorization request message specifies a transaction amount which corresponds to a value of the purchase. In another embodiment, the payment authorization request message specifies a nominal transaction amount, which may be independent of the value of the purchase.

In some embodiments, the supplementary data comprises account data identifying a digital wallet associated with the cardholder. Operation (b) may comprise transmitting the account data for extraction by the terminal of the merchant thereby causing the purchase to be funded by the digital wallet.

In some embodiments, the supplementary data may be incorporated in the payment authorization response message only in response to a positive outcome of the payment authorization request.

According to a second aspect, there is provided a system for processing a payment transaction associated with a purchase made at a merchant. The payment transaction involves a payment card. The system comprises:

an authorization engine component operative to:

(a) receive a payment authorization request message from a payment network server, said payment authorization request message specifying said payment transaction to the merchant, and
(b) in response to the payment authorization request message, generate a payment authorization response message indicative of an outcome of the payment authorization request for communication to a terminal of the merchant; and a response-generation engine component communicatively coupled to the authorization engine component, the response-generation engine being operative to:
(i) identify supplementary data associated with a cardholder of the payment card, wherein the supplementary data comprises data pre-registered by the cardholder with the system, and
(ii) incorporate the supplementary data in the payment authorization response message for communication to the terminal of the merchant for extraction by the merchant.

The above system may be implemented by one or more processors and a data storage device storing program instructions being operative to cause the one or more processors to carry out the above method steps.

In some embodiments, the system may comprise a database which stores a respective set of data pre-registered by the cardholder for each of a plurality of merchants. The response-generation engine component may be operative to interrogate the database to identify the set of data corresponding to the merchant as the supplementary data.

In one example, the system may comprise a database engine component operative to receive user-specified data from a communication device associated with the cardholder, and store, in the database, an association between the user-specified data and the cardholder. The association may specify an association between the user-specified data and the payment card. The database may store data pre-registered by each of a plurality of cardholders. The supplementary data may comprise data identifying a loyalty account associated with the cardholder, and the loyalty account may be associated with the merchant.

In some embodiments, the payment authorization request message specifies a transaction amount which corresponds to a value of the purchase. In another embodiment, the payment authorization request message specifies a nominal transaction amount (such as a zero transaction value, or a minimum non-zero transaction amount in a given currency such as the currency of the payment card or the currency in the country in which the transaction is taking place, for example $0.01, ¥1, €0.01, £0.01, etc.), which may be independent of the value of the purchase.

In some embodiments, the supplementary data may comprise account data identifying a digital wallet associated with the cardholder, and the response-generation engine component is operative to transmit the account data for extraction by the terminal of the merchant thereby causing the purchase to be funded by the digital wallet.

In some embodiments, the response-generation engine component may be operative to incorporate the supplementary data in the payment authorization response message only in response to a positive outcome of the payment authorization request.

According to a third aspect, there is provided a method for processing a payment transaction associated with a purchase made at a merchant, the method comprising:

(a) receiving, by a payment terminal of the merchant, payment card information for the payment transaction;
(b) transmitting, by the payment terminal, a payment authorization request message to a payment network server for authorization by an issuer system associated with the payment card, said payment authorization request message specifying said payment transaction including the payment card information; and
(c) receiving, by the payment terminal, a payment authorization response message indicating an outcome of the payment authorization request from the payment network server thereby completing the payment authorization request;

wherein the method further comprises:

(d) determining, by the payment terminal, if the payment authorization response message further comprises supplementary data, and if the determination is positive, extracting the supplementary data to initiate a related transaction between the merchant and the cardholder in respect of the purchase using the extracted supplementary data.

In some embodiments, operation (d) may comprise extracting the supplementary data to identify a loyalty account associated with the merchant, and the related transaction may comprise a loyalty transaction involving the loyalty account. The supplementary data comprises data which is pre-registered by the cardholder with an issuer bank of the payment card. According to one particular example, extracting the supplementary data may comprise parsing an authorization response message received by the merchant.

In some embodiments, the method may further comprise accessing a database storing loyalty program data associated with one or more loyalty accounts. The database may be maintained by the merchant. The loyalty program data associated with the loyalty account may be updated by the merchant using the loyalty transaction.

In some embodiments, operation (d) may comprise extracting the supplementary data to identify a digital wallet associated with the cardholder, and the related transaction may comprise a digital-wallet payment transaction for funding the purchase using the digital wallet.

In some embodiments, the payment authorization request message specifies a transaction amount corresponding to a value of the purchase. In another embodiment, the payment authorization request message specifies a nominal transaction amount.

According to a further aspect, there is provided a payment terminal for processing a payment transaction associated with a purchase made at a merchant. The payment terminal comprises a processor, a communication interface, and a data storage device storing program instructions operative when implemented by the processor to cause the processor to:

(a) receive payment card information for the payment transaction;
(b) transmit, via the communication interface, a payment authorization request message to a payment network server for authorization by an issuer system associated with the payment card, said payment authorization request message specifying said payment transaction including the payment card information; and
(c) receive, via the communication interface from the payment network server, a payment authorization response message indicative of an outcome of the payment authorization request from the payment network server thereby completing the payment authorization request;

the program instructions being operative to further cause the processor to:

(d) determine if the payment authorization response message further comprises supplementary data, and if the determination is positive, extract the supplementary data to initiate a related transaction between the merchant and the cardholder in respect of the purchase using the extracted supplementary data.

In some embodiments, the payment terminal may comprise a data input device configured to read the payment card information for transmission the processor. For example, the data input device may be a point-of-sales (POS) terminal maintained at the merchant's premises.

In some embodiments, the program instructions may be operative to cause the processor to extract the supplementary data to identify a loyalty account associated with the merchant. The related transaction may comprise a loyalty transaction involving the loyalty account.

In some embodiments, the program instructions may be operative to further cause the processor to access a database storing loyalty program data associated with one or more loyalty accounts. The loyalty program data associated with the loyalty account may be updated by the merchant using the loyalty transaction.

In some embodiments, the program instructions may be operative to cause the processor to extract the supplementary data to identify a digital wallet associated with the cardholder. The related transaction may comprise a digital-wallet payment transaction for funding the purchase using the digital wallet.

In some embodiments, the payment authorization request message specifies a transaction amount corresponding to a value of the purchase. In another embodiment, the payment authorization request message specifies a nominal transaction amount.

The present disclosure further proposes a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor, to cause the processor to perform any one of the methods described above.

All operations of the proposed methods are preferably performed automatically. The term “automatic” is used in this document to refer to a process which is performed substantially without human involvement, save possibly for initiation of the process.

As used in this document, the term “payment card” refers to any cashless payment device associated with a payment account, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, wearable devices, transponder devices, NFC-enabled devices, and/or computers. For example, a digital wallet (e.g. a wallet application running on such device) may store or be linked to payment account information associated with a credit card or debit card which an owner holds.

Note that the term “product” is used in this document to include any of physical objects, data products (such as music or software) or services.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Embodiments of the disclosure will now be described by way of example only with reference to the following drawings, in which:

FIG. 1 shows a computerized payment system which is suitable to perform a method according to the present disclosure;

FIG. 2 is a flow diagram of an exemplary method according to one embodiment;

FIG. 3 is a flow diagram of an exemplary method according to another embodiment;

FIG. 4 is a flow diagram of an exemplary method according to another embodiment;

FIG. 5 is a flow diagram of an exemplary method according to a further embodiment;

FIG. 6 shows the technical architecture of a server of the computerized payment system of FIG. 1; and

FIG. 7 shows the technical architecture of a payment terminal of the computerized payment system of FIG. 1.

### DETAILED DESCRIPTION

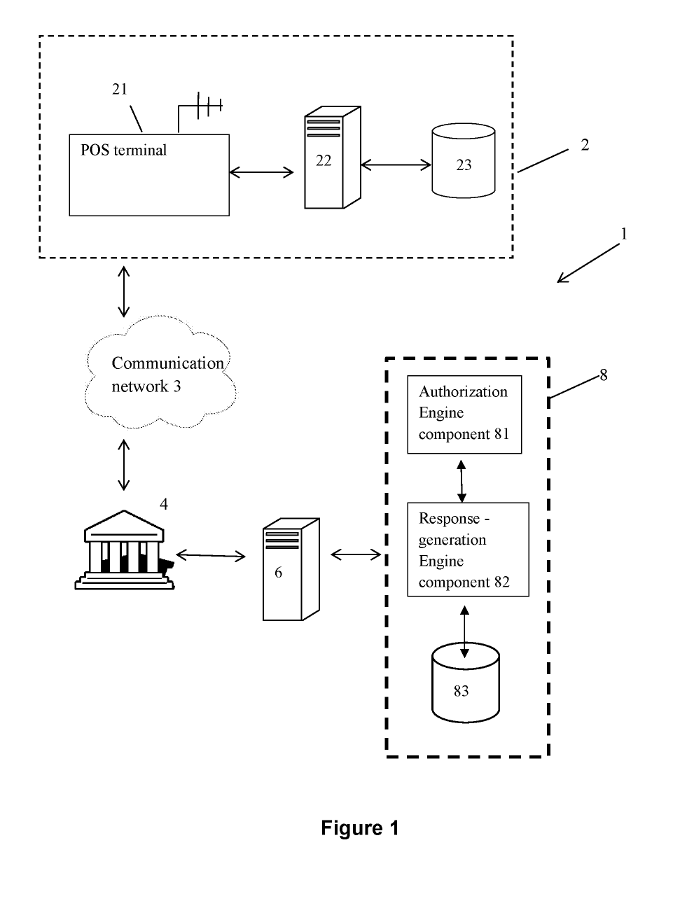

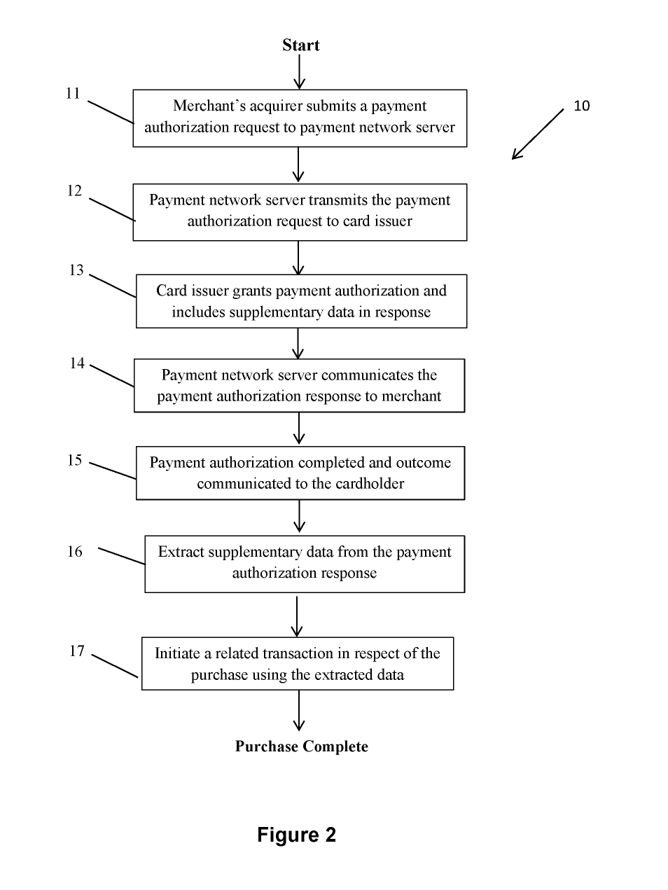

Referring to FIG. 1, a computerized payment system 1 is shown which is suitable for performing methods of embodiments as illustrated by FIGS. 2-5.

The computerized payment system 1 comprises a payment network server 6 which facilitates an electronic payment transaction between a cardholder of a payment card such as a credit card or debit card, and a merchant system 2. In this embodiment, the merchant system 2 comprises a POS (point-of-sale) terminal 21 operable to read the details of a payment card, and prepare a payment transaction request for submission via a payment gateway for processing by the payment network server 6. The payment network server 6 is in communication with an issuer system (e.g. an issuing bank server 8 operated by an issuing bank) and an acquirer system (e.g. an acquiring bank server 4 operated by an acquiring bank). As will be understood by a skilled person in the art, the payment network server 6 may be constituted by a payment processing organization such as MasterCard, having suitable processing apparatus. In addition, the computerized payment system 1 typically comprises a plurality of issuing banks and acquiring banks in communication with the payment network server 6.

Typically, a payment transaction starts with the cardholder presenting the payment card to a merchant which has a card acceptance device such as a POS (point-of-sale) terminal 21 operable to read the details of the payment card, and prepare an authorization request message and transmit to the acquiring bank server 4 at which the merchant maintains an account. The transmission is carried out over a communication network 3. The authorization request message includes data encoding the payment card details and the transaction/payment amount of the purchase. The acquirer bank server 4 contacts the payment network server 6 of the computerized payment system 1, and passes on the data encoding payment card details and the amount of the purchase. The payment network server 6 uses the payment card details to identify the issuer bank, and sends the payment card details and the amount of the purchase to the issuing bank server 8. The issuer bank server 8 identifies the associated cardholder and payment account and determines either to authorize or deny the purchase, and sends a corresponding message to the payment network server 6. If the issuer bank server 8 authorized the transaction, then the purchase is now completed and goods may be released to the cardholder. At some later time (during clearing and settlement operations), the issuing bank transfers the payment amount to the acquiring bank.

Specifically, in this embodiment, the issuing bank server 8 comprises two engine components: an authorization engine component 81 and a response-generation engine component 82 which are in data communication. The authorization engine component 81 is configured to determine whether to authorize or deny a payment transaction. This may include determining, for a given cardholder and/or a payment card, if the account balance of the cardholder is sufficient to cover the payment amount. The authorization engine component 81 may also carry out fraudulent activity check. Based on an outcome of the determination by the authorization engine component 81, the response-generation engine component 82 may generate a payment authorization response message indicating whether to grant or deny authorization request for the transmission to the payment network server 6.

The issuing bank server 8 further comprises a supplementary database 83. The supplementary database stores a pre-defined association between a payment card held by the cardholder at the issuing bank, and supplementary data which is pre-registered by him or her at the issuing bank. The response-generation engine component 82 is configured to interrogate the supplementary database 83 to identify, for a given cardholder, the corresponding stored supplementary data associated with the cardholder. Further, the response-generation engine component 82 is configure to includes the identified supplementary data in the payment authorization response message for transmission to the payment network server 6, which then communicates the response message to the POS terminal 21. In another example, the supplementary database 83 is stored remotely from the issuing bank server 8 and is made remotely accessible to the issuing bank server 8.

The supplementary data may include any user-specified information pre-registered by the cardholder with the issuing bank server 8. In particular, a registration step may be carried out with the issuing bank, in which the cardholder supplies such information electronically via an online-banking application portal operated by the issuing bank. According to a particular example, the customer may be prompted to enter his or her loyalty account information in a pre-defined field on a designated web page rendered via a graphic user-interface of the customer's communication device such as a mobile phone or laptop. The loyalty information may include one or more of the following: a name of the loyalty program, an identity of the merchant and a loyalty account number, e.g. a membership ID. The loyalty information may be entered in a pre-defined format, such as a merchant's name followed by a membership number separated by a hyphen (e.g. SAFEWAY-123456). In addition, loyalty account information associated with more than one loyalty accounts may be provided for the issuing bank server 8. In one example, the loyalty information associated with three merchants: Safeway, Sears, and Macy's, may be provided in a format as follows: “SAFEWAY-123456 SEARS-123457 MACYS-123458”.

Note that the pre-registered data may be associated with one or more payment cards, as a cardholder may hold more than one payment card at the bank. In one embodiment, the cardholder may specify a respective set of information to be associated with each of the one or more payment cards maintained at the bank. In other words, the information associated with the respective payment cards of the cardholder may be the same or different.

Alternatively or additionally, the cardholder may specify a respective set of information to be associated with different merchants. In other words, the information associated with the respective merchants may be the same or different. As such, the supplementary database 83 may store pre-defined mappings between the user-specified data and the associated respective merchants so that the issuer may include different sets of supplementary data for payment authorization response messages to be sent to different merchants.

The supplementary data may include loyalty program information associated with a cardholder. Specifically, the loyalty program information may include loyalty information for a loyalty account held by the cardholder who enrolled a merchant's loyalty program. The loyalty program information may include loyalty information relating to a plurality of loyalty accounts held by the cardholder at respective merchants. The supplementary data may alternatively or additionally comprise other use-specified data, such as an account data of a digital wallet associated with the cardholder.

Typically, the supplementary database 83 maintained by the issuing bank stores pre-registered information associated with a plurality of cardholders who hold payment cards at the bank. The response-generation engine component 82 of the issuing bank server 8 is configured, in response to the authorization request message in connection with a payment card, to interrogate the supplementary database 83 to obtain the associated supplementary data for the cardholder.

The merchant system 2 further comprises a server which is in communication with the POS terminal 21 for processing or issuing commands at the merchant's end. In this example, the server is a loyalty program server 22 maintained by the merchant which organizes loyalty programs for its customers. The loyalty program server 22 may be configured to administer the loyalty programs. In particular, the merchant 2 maintains a loyalty database 23 storing loyalty information for respective loyalty accounts held by the respective customers who enrolled in the merchant's loyalty program. The loyalty program server 22 is in data communication with the loyalty database 23 and is configured to access the loyalty database 23 to obtain or modify loyalty information (such as loyalty rewards or points) associated with the loyalty account.

As will be understood by a skilled person, each of the various devices in the computerized payment system 1 has a communication module such as wireless interface for two-way communication between one and another via a communication network. The communication network could be any types of network, for example, virtual private network (VPN), the Internet, a local area and/or wide area network (LAN and/or WAN), and so on.

Exemplary methods of the present disclosure will now be illustrated with reference to FIGS. 2-5 in which the operations are enumerated. It should also be noted that enumeration of operations is for purposes of clarity and that the operations need not be performed in the order implied by the enumeration.

Referring to FIG. 2, in which an exemplary process 10 of processing a payment transaction is illustrated. The process 10 is illustrated with respect to an electronic payment transaction involving a payment card, such as a credit card, associated with a purchase of products made at the merchant. In general, the purchase may be funded by monetary currency, loyalty programs such as loyalty points, and/or other programs etc.

At step 11, the merchant's acquiring bank 4 receives from the merchant's POS terminal 21 a payment authorization request message for a payment transaction associated with a purchase made at the merchant. The payment authorization request message may be generated by the POS terminal 21 which specifies details of the payment transaction. The details may comprise information including a payment amount, payment credentials (e.g. PAN), an acquirer identifier/card accepter identifier. It may also comprise further information such as merchant category code (also known as card acceptor business code), cardholder base currency (i.e., U.S. Dollars, Euros, Yen, etc.), transaction time and date, location (full address and/or GPS data), and/or terminal identifier (e.g., merchant terminal identifier or ATM identifier). The payment authorization request message is transmitted to the payment network server 6 by the acquiring bank 4.

At step 12, the payment network server 6 identifies the card issuing bank and transmits the payment authorization request message to the issuing bank server 8.

At step 13, in response to the payment authorization request message, the authorization engine component 81 of the issuing bank server 8 makes a determination whether to authorize or deny the payment as described earlier. The response-generation engine component 82 accordingly constructs a payment authorization data structure in the form of a payment authorization response message for transmission to the payment network. At this step, the response-authorization engine component 82 also interrogates the supplementary database 83 to identify supplementary data pre-registered by the cardholder. The identified data is included in the payment authorization response message for transmission to the payment network server 6. For example, the identified supplementary data may be included in a pre-defined section (such as a “comment” section) of the data structure of the payment authorization response message.

At step 14, the payment network server 6 communicates the payment authorization response message to the merchant via the POS terminal 21. The payment authorization stage completes at step 15 and the outcome of authorization is communicated to the cardholder.

At step 16, the merchant's POS terminal determines if the payment authorization response message further comprises supplementary data which the cardholder had previously registered with the issuing bank. If the determination is positive, the supplementary data is extracted. This step may be performed by parsing the payment authorization response message to identify and extract the relevant data from the data structure.

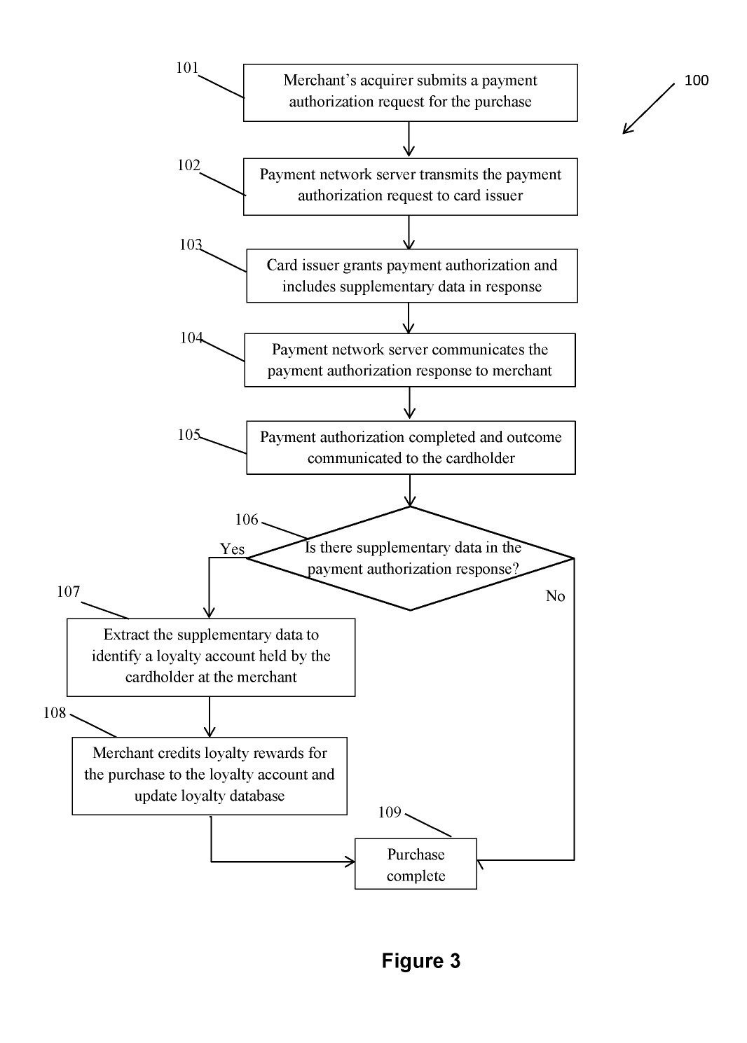

At step 17, a related transaction in respect of the purchase is initiated by the merchant using the extracted data. The related transaction may be a loyalty-related transaction in respect of the purchase, or a payment transaction involving another payment mechanism for funding the purchase at the merchant, as will be described in more detail with references to examples illustrated in FIGS. 3-5.

In some embodiments, the supplementary database 83 may store a respective set of data pre-registered by the cardholder for each of a plurality of merchants. In one example, the response-generation engine component 82 may include all identified supplementary data in the response message for transmission to the merchant's POS terminal 21 at step 103. The merchant's POS terminal 21 may extract relevant data for initiating a related transaction at step 17. In another example, the response-generation engine component 82 may identify from the supplementary database 83 the set of stored data associated with the merchant as the supplementary data and include them in the payment authorization response message. The identity of the merchant may be identified from the merchant's identifier and/or other merchant-related transaction data included in the payment authorization request message. In some embodiment, the cardholder may be given an option to configure, for example at the initial registration step, an association between the respective sets of user-specified data and respective merchants, so that the data to be included by the response-generation engine component 82 in the response message to different merchants or groups of merchants may be pre-defined and/or customized by the cardholder.

In some embodiments, the response-generation engine component 82 is configured to include the supplementary data in the payment authorization response message only if the outcome of the payment authorization request determined by the authorization engine component 81 is positive.

Turning to FIG. 3, a process 100 is illustrated with respect to an electronic payment transaction for a making purchase at the merchant using a credit card. The merchant system 2 receives the credit card information. This may be performed by a data input device such as the merchant's POS terminal reading the credit information via a chip-card reader or via a contact-less communication interface such as a NFC reader. The merchant system 2 prepares a payment authorization request message specifying the payment amount, the payment card details and other transaction details to the acquiring bank. In this example, the payment amount specifies the amount to be charged to the credit card for funding the purchase, that is, the amount corresponds to the value of the purchase of products.

Steps 101-105 are performed in a similar manner as steps 11-15 previously described with reference to the method 10 of FIG. 2.

At step 106, the merchant's POS terminal 21 determines if the payment authorization response message further comprises supplementary data pre-registered by the cardholder with the issuer bank. Similarly, the determination may be performed by parsing the payment authorization response message. If the determination is negative, the purchasing transaction completes and the control of the purchase products may be relinquished to the customer. If the determination is positive, the supplementary data is extracted by the merchant to initiate another transaction related to the present purchase. In this embodiment, the supplementary data is parsed by the POS terminal 21 at step 107 to identify a loyalty account by a membership ID of a loyalty program organized by the merchant. As will be understood by a skilled person, steps 106 and 107 may be performed in a single operation.

At step 108, a loyalty transaction involving the loyalty account is carried out. This may be operated by the loyalty server 22 of the merchant system 2. The loyalty server 22 is configured to access a loyalty database 23 which stores loyalty information (such as earned loyalty rewards and/or loyalty points) associated with one or more loyalty accounts. The loyalty server 22 identifies the loyalty information associated with the identified loyalty account and updates the stored loyalty information associated with the loyalty account based on the loyalty transaction. In particular, the merchant may determine corresponding loyalty rewards earned by the cardholder for the purchase, and credit them into the loyalty account to update the entries of the loyalty database 23 accordingly. The loyalty rewards or loyalty points may be credited to the loyalty account in accordance with terms and/or rules of a loyalty program. As will be understood by a skilled person, the loyalty program may be administered by the merchant solely, or jointly with one or more other merchants or organizations.

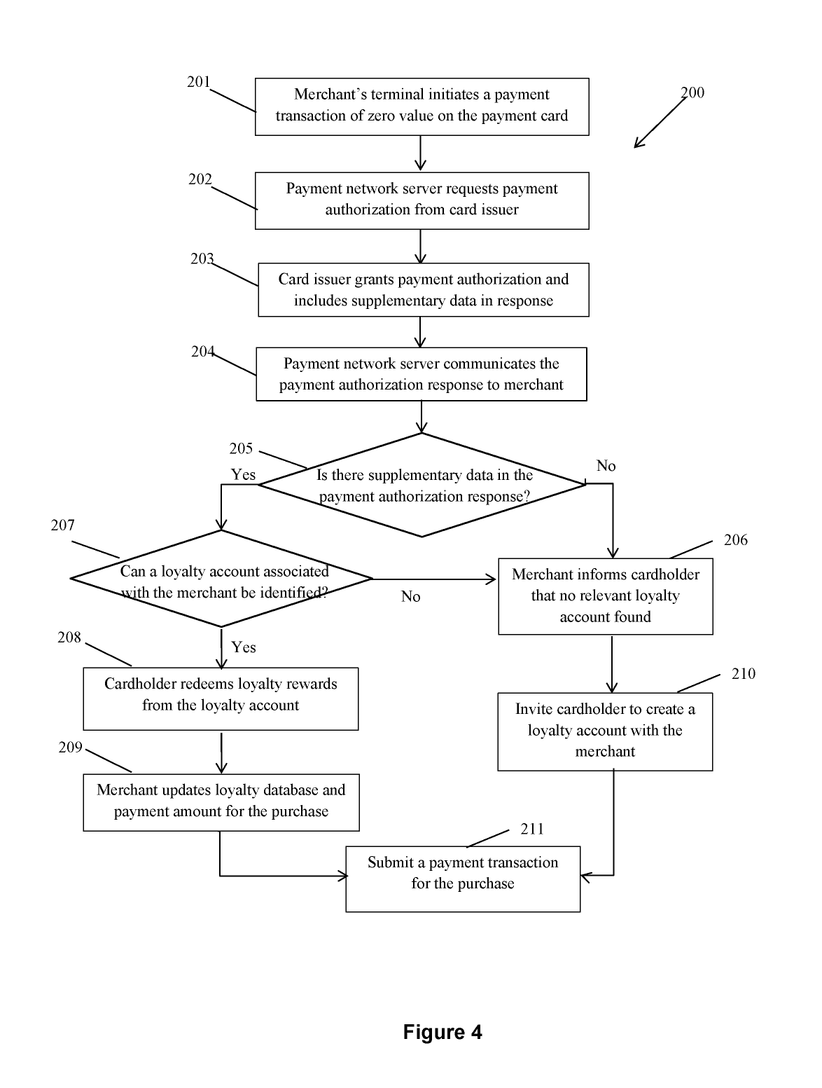

Turning to FIG. 4, a process 200 of performing a loyalty-redemption transaction between the cardholder and the merchant is illustrated. Specifically, the loyalty-redemption transaction is carried out with a payment transaction at the merchant.

When a customer wishes to make a loyalty-redemption at the merchant, he or she may initiate the redemption process by presenting his or her credit card to the merchant. At step 201, the merchant's terminal initiates a payment transaction of a zero value on the payment card. In other words, the payment authorization request message specifies a zero transaction amount. In a variant, the request message may specify another nominal amount, which may be independent of a value of the purchase.

Steps 202-204 are then performed in a similar manner as steps 102-104 which include processing the payment authorization request message over the payment network so a corresponding payment authorization response message is received by the merchant's terminal 21 at step 204. In this example, the issuing bank server 8 is configured to incorporate all data pre-registered by the cardholder as supplementary data in the payment authorization response message for transmission to the merchant's POS terminal 21.

At step 205, the merchant's POS terminal 21 determines if the payment authorization response message further comprises supplementary data pre-registered by the cardholder with the issuer bank. If the determination is positive at step 205, the supplementary data is extracted by the merchant's POS terminal 21 at step 207.

In particular, step 207 may comprise a step of parsing the supplementary data to identify a loyalty account which is associated with the present merchant. In this example, the merchant first identifies if the supplementary data contains data associated with the loyalty program organized by the merchant. This may be identified based on a search for a string containing the merchant's name, e.g. a string containing the merchant's name “Safeway”. Then, the associated membership ID (e.g. 123456) in the string is extracted and compared against the loyalty database 23 to determine if there is a matching entry in the loyalty database 23 comprising a corresponding membership ID.

If the determination at either of step 205 or step 207 is negative, the merchant may inform the cardholder that no relevant loyalty account is found at step 206. In this embodiment, the cardholder is then invited to create a loyalty account with the merchant at step 210, for example, by signing up for the loyalty program organized by the merchant. At step 211, a subsequent payment transaction may be submitted for funding a purchase made at the merchant, and the customer may start accumulating loyalty points for this purchase with the created loyalty account at the merchant.

If the determination at step 207 is positive, the loyalty server 22 of the merchant 2 retrieves from the loyalty database 23 the loyalty information associated with the identified loyalty account, e.g. the membership ID. The cardholder is informed of the loyalty information by the merchant. The loyalty information comprises data indicative of loyalty rewards available for redemption by the cardholder. At step 208, the cardholder communicates to the merchant about the loyalty rewards or points he or she wishes to redeem from the account.

At step 209, the merchant applies the redemption and updates the loyalty information in loyalty database 23 accordingly. In this example, the loyalty redemption results in a discount to be applied on the current purchase. At step 211, the merchant submits a payment transaction of a discounted amount as a result of the redemption, so that the discounted amount is charged to the cardholder for this purchase. Depending on the terms of the loyalty program, the merchant 2 may allow further loyalty points to be earned for the purchase and may update the loyalty database 23 accordingly upon the purchase being completed.

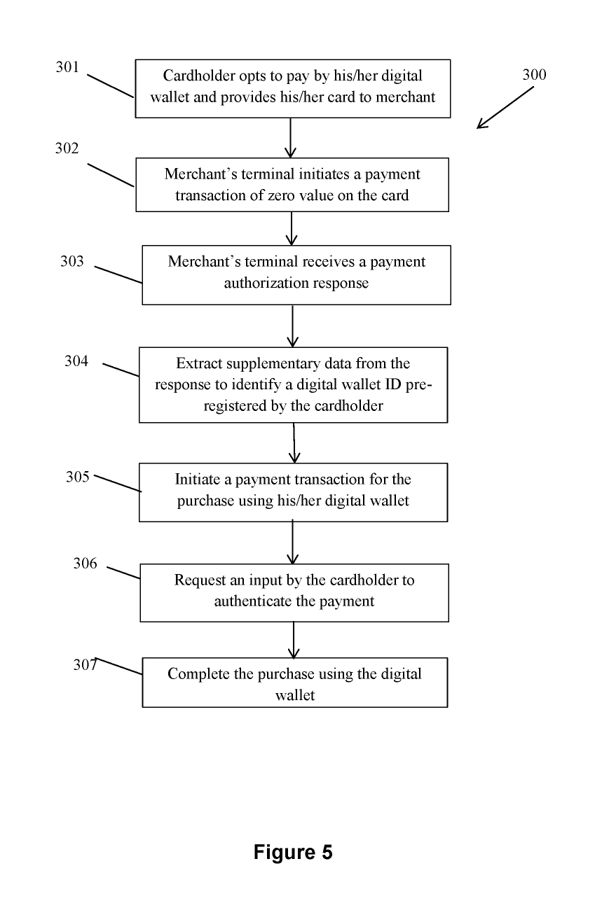

FIG. 5 illustrates a flow of another exemplary method 300 according to the present disclosure. The method 300 illustrates a process of performing a payment transaction associated with a purchase at the merchant using a payment card, while funding the actual amount of purchase by an alternative payment mechanism. In other words, the customer may initiate a transaction with the merchant by presenting his or her payment card, while charging the actual amount of purchase to another payment mechanism, such as a digital wallet, instead of to the payment card presented to the merchant.

At step 301, the cardholder presents a payment card to the merchant and informs the merchant that he or she wishes to pay using a digital wallet, such as by Paypal. Note that Paypal may or may not have stored the payment card details of the card presented to the merchant.

At step 302, the merchant's terminal 21 similarly initiates a payment transaction of a zero value on the payment card. In other words, the payment authorization request message specifies a zero transaction amount. In a variant, the request message may specify another nominal amount, which may be independent of a value of the purchase.

At step 303, the merchant's terminal 21 receives a payment authorization response message. In this example, the payment authorization response message includes account data identifying a Paypal account pre-registered by the cardholder with the issuing bank server 8. In some embodiment, the payment authorization response message may include further account data identifying other digital wallets or payment mechanisms, and the cardholder selects the payment mechanism he or she wishes to use to fund the purchase. Additionally, the payment authorization response message may include data identifying loyalty accounts as described in the earlier embodiments.

At step 304, the merchant system 2 parses the supplementary data to identify a digital wallet associated with the cardholder and initiates a digital-wallet payment transaction for funding the purchase. In this example, the Paypal account ID is extracted by the merchant's terminal 21 and it initiates a payment transaction at step 305 to charge the amount of purchase to the Paypal account. This wallet based transaction may be processed in a conventional way. In particular, the merchant may request an input by the cardholder to authenticate the payment at step 306 to complete the purchase at step 307.

In the embodiments described above, the supplementary data is incorporated into the payment authorization response message only if the outcome of the payment authorization request is positive. In a variant, the supplementary data may also be included if the payment authorization is denied, for example, if the authorization engine 81 determines that the payment amount has exceeded the credit limit granted to the cardholder. In that case, account data identifying an alternative payment mechanism (e.g. a digital wallet ID) may be included automatically as the supplementary data for transmission to the merchant so that the cardholder is automatically offered to use the alternative payment mechanism to fund the transaction, instead of having to initiate a zero value transaction at step 302 to trigger the process. In some embodiments, the cardholder may set rules, e.g. at the registration step, to configure the content of supplementary data which is communicated by issuing bank server 8 to the merchant based on an authorization outcome and/or merchant's identity.

In addition, the method 300 may be combined with methods 100 or 200 so that loyalty-related transactions may be concurrently carried out for the purchase, if desired.

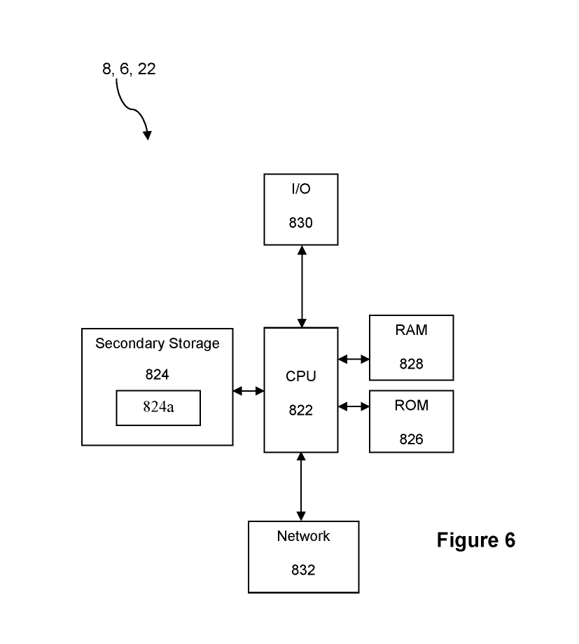

FIG. 6 is a block diagram showing a technical architecture of a server computer (e.g. the issuing bank server 8, the payment network server 6 or the loyalty program server 22) suitable for implementing the present method.

The technical architecture includes a processor 822 (which may be referred to as a central processor unit or CPU) that is in communication with memory devices including secondary storage 824 (such as disk drives), read only memory (ROM) 826, random access memory (RAM) 828. The processor 822 may be implemented as one or more CPU chips. The technical architecture may further comprise input/output (I/O) devices 830, and network connectivity devices 832.

The secondary storage 824 is typically comprised of one or more disk drives or tape drives and is used for non-volatile storage of data and as an over-flow data storage device if RAM 828 is not large enough to hold all working data. Secondary storage 824 may be used to store programs which are loaded into RAM 828 when such programs are selected for execution.

In this embodiment, the secondary storage 824 has a processing component 824a comprising non-transitory instructions operative by the processor 822 to perform various operations of the method of the present disclosure. The ROM 826 is used to store instructions and perhaps data which are read during program execution. The secondary storage 824, the RAM 828, and/or the ROM 826 may be referred to in some contexts as computer readable storage media and/or non-transitory computer readable media.

I/O devices 830 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 832 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 832 may enable the processor 822 to communicate with the Internet or one or more intranets. With such a network connection, it is contemplated that the processor 822 might receive information from the network, or might output information to the network in the course of performing the above-described method operations. Such information, which is often represented as a sequence of instructions to be executed using processor 822, may be received from and outputted to the network, for example, in the form of a computer data signal embodied in a carrier wave.

The processor 822 executes instructions, codes, computer programs, scripts which it accesses from hard disk, floppy disk, optical disk (these various disk based systems may all be considered secondary storage 824), flash drive, ROM 826, RAM 828, or the network connectivity devices 832. While only one processor 822 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 822, the RAM 828, and the ROM 826 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

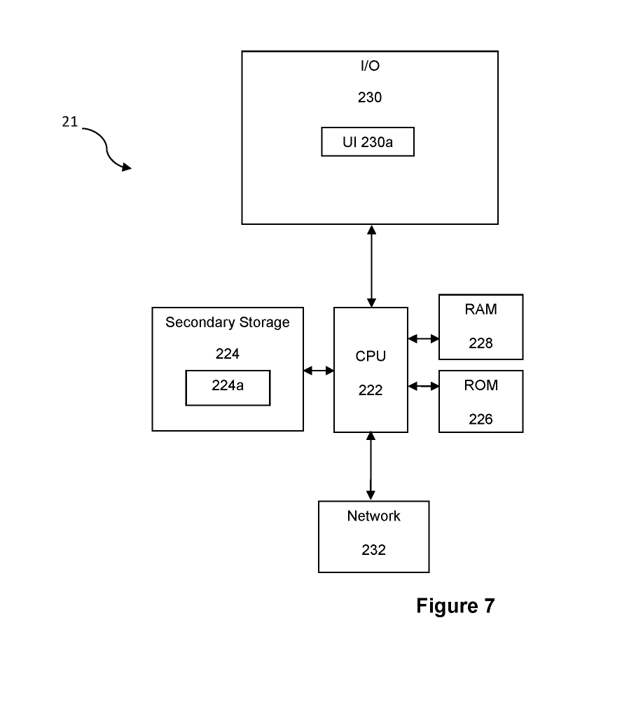

FIG. 7 is a block diagram showing a technical architecture of a payment terminal (e.g. the merchant's payment terminal 21). The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further comprises input/output (I/O) devices 230, and network connectivity devices 232.

The I/O devices comprise a consumer interface (UI) 230. The UI 230a may comprise a screen in the form of a touch screen, a keyboard, a keypad or other known input device.

The secondary storage 224 is typically comprised of a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure. For example, other than the POS terminal 21 of the merchant system 2, the payment terminal of the merchant system 2 may alternatively be a merchant's web-server which may receive payment card details over the internet from a user's communication device in respect of an online purchase. Thus the merchant system 2 may operate without a data input terminal for reading the payment card details. The merchant's web-server may then forward the payment transaction to the payment gateway for processing, and extract relevant supplementary data (e.g. the membership ID) from the response message received from the issuer system.

1. A system for processing a payment transaction associated with a purchase made at a merchant, said payment transaction involving a payment card, the system comprising:
an authorization engine component operative to:
(a) receive a payment authorization request message from a payment network server, said payment authorization request message specifying said payment transaction to the merchant, and
(b) in response to the payment authorization request message, generate a payment authorization response message indicative of an outcome of the payment authorization request for communication to a terminal of the merchant; and
a response-generation engine component communicatively coupled to the authorization engine component, the response-generation engine being operative to:
(i) identify supplementary data associated with a cardholder of the payment card, wherein the supplementary data comprises data pre-registered by the cardholder with the system, and
(ii) incorporate the supplementary data in the payment authorization response message for communication to the terminal of the merchant for extraction by the merchant.

2. The system according to claim 1, wherein the system comprises a database storing a respective set of data pre-registered by the cardholder for each of a plurality of merchants, and wherein the response-generation engine component is operative to interrogate the database to identify the set of data corresponding to the merchant as the supplementary data.

3. The system according to claim 2, comprising a database engine component operative to:
receive user-specified data from a communication device associated with the cardholder, and
store, in the database, an association between the user-specified data and the cardholder.

4. The system according to claim 3, wherein the association specifies an association between the user-specified data and the payment card.

5. The system according to claim 1, wherein the supplementary data comprises data identifying a loyalty account associated with the cardholder.

6. The system according to claim 1, wherein the payment transaction has a transaction amount corresponding to a value of the purchase.

7. The system according to claim 1, wherein the payment transaction has a nominal transaction amount, and wherein the supplementary data comprises account data identifying a digital wallet associated with the cardholder, and wherein the response-generation engine component is operative to transmit the account data for extraction by the terminal of the merchant thereby causing the purchase to be funded by the digital wallet.

8. A method for processing a payment transaction associated with a purchase made at a merchant, said payment transaction involving a payment card associated with an issuer system, the method comprising:
(a) receiving a payment authorization request message from a payment network server, said payment authorization request message specifying said payment transaction to the merchant, and
(b) in response to the payment authorization request message, generating a payment authorization response message indicative of an outcome of the payment authorization request for communication to a terminal of the merchant;
wherein operation (b) further comprises:
(i) identifying supplementary data associated with a cardholder of the payment card, wherein the supplementary data comprises data pre-registered by the cardholder with the issuer system, and
(ii) incorporating the supplementary data in the payment authorization response message for communication to the terminal of the merchant for extraction by the merchant.

9. The method according to claim 8, wherein operation (i) comprises interrogating a database storing a respective set of data pre-registered by the cardholder for each of a plurality of merchants, and identifying the set of data corresponding to the merchant as the supplementary data.

10. The method according to claim 9, comprising updating the database by:
receiving user-specified data from a communication device associated with the cardholder, and
storing an association between the user-specified data and the cardholder by the database.

11. The method according to claim 10, wherein the association specifies an association between the user-specified data and the payment card.

12. The method according to claim 8, wherein the supplementary data comprises data identifying a loyalty account associated with the cardholder.

13. The method according to claim 8, wherein the payment authorization request message specifies a transaction amount corresponding to a value of the purchase.

14. The method according to claim 8, wherein the payment authorization request message specifies a nominal transaction amount, and wherein the supplementary data comprises account data identifying a digital wallet associated with the cardholder, and wherein operation (b) comprises transmitting the account data for extraction by the terminal of the merchant thereby causing the purchase to be funded by the digital wallet.

15. A payment terminal for processing a payment transaction associated with a purchase made at a merchant, the payment terminal comprising a processor, a communication interface, and a data storage device storing program instructions operative when implemented by the processor to cause the processor to:
(a) receive payment card information for the payment transaction;
(b) transmit, via the communication interface, a payment authorization request message to a payment network server for authorization by an issuer system associated with the payment card, said payment authorization request message specifying said payment transaction including the payment card information; and
(c) receive, via the communication interface from the payment network server, a payment authorization response message indicative of an outcome of the payment authorization request, thereby completing the payment authorization request;
the program instructions being operative to further cause the processor to:
(d) determine if the payment authorization response message further comprises supplementary data, and if the determination is positive, extract the supplementary data to initiate a related transaction between the merchant and the cardholder in respect of the purchase, using the extracted supplementary data.

16. The payment terminal according to claim 15, further comprising a data input device configured to read the payment card information for transmission to the processor.

17. The payment terminal according to claim 15, wherein the program instructions are operative to cause the processor to extract the supplementary data to identify a loyalty account associated with the merchant; and wherein the related transaction comprises a loyalty transaction involving the loyalty account.

18. The payment terminal according to claim 17, wherein the program instructions are operative to further cause the processor to access a database storing loyalty program data associated with one or more loyalty accounts, and to update the loyalty program data associated with the loyalty account using the loyalty transaction.

19. The payment terminal according to claim 15, wherein the program instructions are operative to cause the processor to extract the supplementary data to identify a digital wallet associated with the cardholder; and wherein the related transaction comprises a digital-wallet payment transaction for funding the purchase using the digital wallet.

20. The payment terminal according to claim 19, wherein said payment authorization request message specifies a nominal transaction amount.
